(19) United States
(12) Patent Application Publication
(10) Pub. No.: US 2026/0205468 A1
(43) Pub. Date: Jul. 16, 2026

(54) Detecting and Preventing Packet Ingress Between Parallel Redundancy Protocol Local Area Networks

(71) Applicant: Saudi Arabian Oil Company, Dhahran (SA)

(72) Inventors: Abdullah Umar Sheikh, Khobar (SA); Muhammad Zarar Mir, Dammam (SA); Noorul Ameen, Khobar (SA); Maha A. Abduh, Khobar (SA)

(21) Appl. No.: 19/018,433

(22) Filed: Jan. 13, 2025

(51) Int. Cl. H04L 9/40

(52) U.S. Cl. CPC H04L 63/1416; H04L 63/1441

(57) ABSTRACT

A computer implemented method, system, and apparatus that enables detecting and preventing packet ingress between PRP LANs is described. The system includes a first Ethernet switch assigned to LAN A and a second Ethernet switch assigned to LAN B of a Parallel Redundancy Protocol network. The first Ethernet switch and the second Ethernet switch inspect Redundancy Control Trailers (RCTs) of respective data packets and discard data packets that are not assigned to a LAN associated with a respective Ethernet switch as identified in the RCTs of respective data packets.

### TECHNICAL FIELD

This disclosure relates generally to networks in industrial and automation environments, and more particularly, detecting and preventing packet ingress between Parallel Redundancy Protocol (PRP) Local Area Networks (LAN).

### BACKGROUND

Networking protocols are established to provide high availability and redundancy in network communications. Networking protocols encompass a set of rules and conventions that define how data is transmitted and received over a network. These rules ensure that devices on a network can communicate with each other effectively and reliably.

### BRIEF DESCRIPTION OF DRAWINGS

FIG. 1 shows a parallel redundancy protocol (PRP) network system.

FIG. 2 shows an OSI model for network communications.

FIG. 3 shows a PRP network architecture.

FIG. 4 shows a PRP packet structure.

FIG. 5 is a process flow diagram of a process that enables detection and prevention of packet ingress between PRP LANs.

FIG. 6 illustrates hydrocarbon production operations that include both one or more field operations and one or more computational operations, which exchange information and control exploration for the production of hydrocarbons.

FIG. 7 is a schematic illustration of an example controller (or control system) for that enables detection and prevention of packet ingress between PRP LANs.

### DETAILED DESCRIPTION

Detecting and preventing packet ingress between Parallel Redundancy Protocol (PRP) Local Area Networks (LAN) is described herein. In some embodiments, Layer 2 Ethernet switches are configured to store data associated with assignment to a LAN arranged in a PRP system. Ethernet switches of the PRP system inspect a PRP trailer of data packets upon on packet ingress to respective Ethernet switches. In some embodiments, the Ethernet switches discard packets that are not assigned to a same LAN of a respective Ethernet switch. Additionally, in some embodiments predetermined rules are defined to enable shutdown of a violating port of the Ethernet switch (e.g., the port where an incorrect packet ingresses) in response to detecting packets that are not assigned to a same LAN of a respective Ethernet switch. Further, in some embodiments an alarm is generated in response to detecting packets that are not assigned to a same LAN of a respective Ethernet switch. Moreover, in some embodiments in response to detecting packets that are not assigned to a same LAN of a respective Ethernet switch, the detected packets are classified as violating packet(s) and transmitted to an Intrusion Detection System (IDS).

Some advantages of the present techniques include an improvement to Content Addressable Memory (CAM) table stability by preventing issues that arise when the CAM table of an Ethernet switch becomes unreliable or fails to function correctly. By detecting and discarding any violating traffic, Ethernet switches prevent network failure. Under PRP each packet is sent over both LANs. The Ethernet switches as described herein prevent duplicate entries to respective CAM tables and prevent respective Ethernet switches from repeatedly updating their CAM table with the same MAC address but different port entries. Moreover, the present techniques prevent the additional load of handling duplicate packets, thereby preventing exhaustion of a respective Ethernet switch's memory and processing resources, further contributing to CAM table stability.

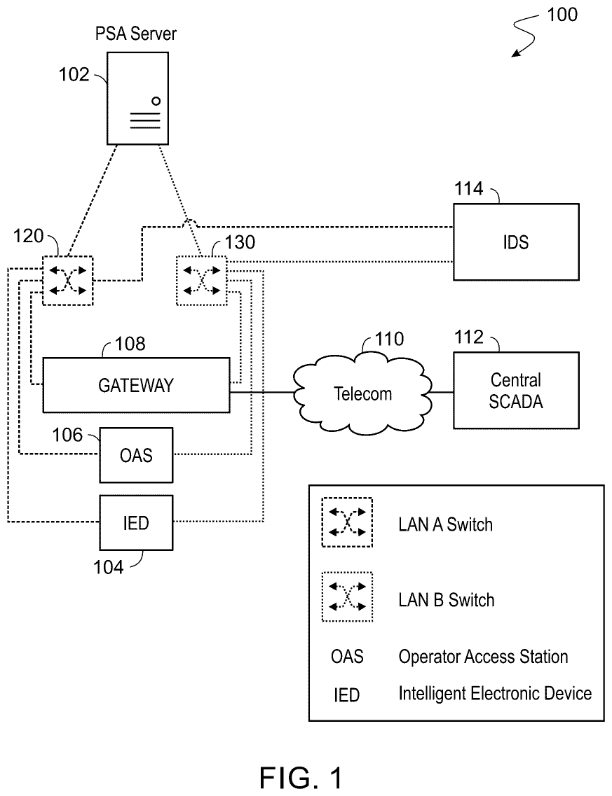

FIG. 1 shows a power systems automation (PSA) framework 100. The PSA framework 100 is configured under the PRP. The computing resource assets can include, for example, a PSA server 102, an intelligent electronic device (IED) 104, an operator access station (OAS) 106, a gateway 108, telecommunications 110, a Central Supervisory Control and Data Acquisition (SCADA) System 112, and an Intrusion Detection System (IDS) 114. The PSA framework 100 is configured with redundant LANs, where switch 120 is assigned to LAN A, and switch 130 is assigned to LAN B.

PRP is a Layer 2 redundancy protocol which works on two independent parallel local area networks, LAN A and LAN B. It uses active topology and transmits data on both LANs at the same time. In an active topology, a signal is actively amplified or regenerated at each step as it passes from one device to the next. This helps maintain the strength and integrity of the signal over longer distances and through multiple devices. Traditionally, a decision is made at the destination node to accept and discard the messages. Both links are active and functional within the network and ethernet switches used between source and destination endpoints will process network traffic by the transmission of PRP packets of data.

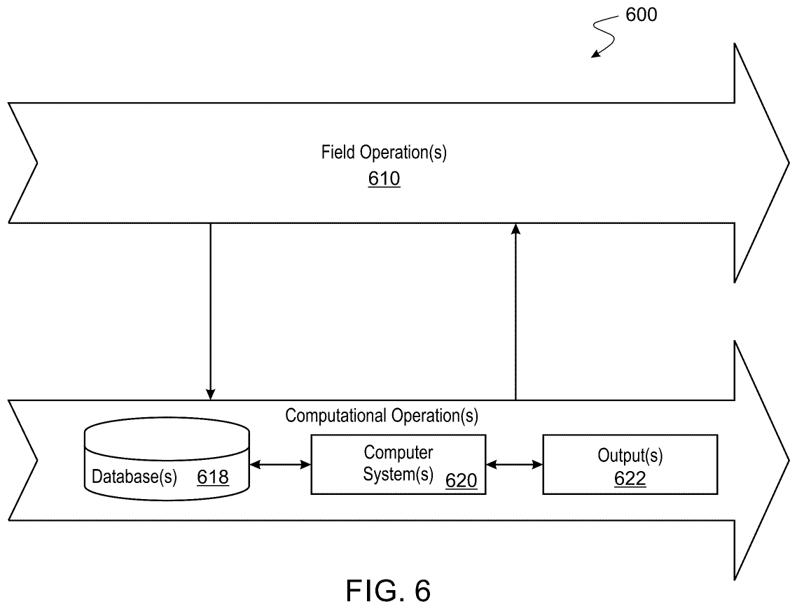

In the example of FIG. 1, the PSA framework 100 is implemented in power systems automation, where technology is used to control and manage power systems. The power systems can be associated with field operations 610 as described with respect to FIG. 6. This involves a combination of instrumentation, control devices, and communication technologies to ensure efficient and reliable operation of power generation, transmission, and distribution systems. Data is acquired from various points in the power system, such as voltage, current, and status of equipment. In examples, this data is gathered using sensors and intelligent electronic devices (IEDs). The collected data is monitored to oversee the status and performance of the power system. This can be done locally or remotely using computer displays and graphical interfaces. In examples, commands are used to control devices to operate the power system. This can include actions like opening or closing circuit breakers, adjusting transformer taps, and controlling generators.

In some embodiments, data is combined from multiple IEDs within a substation to provide a single point of control and monitoring, and can be referred to as substation automation. Each substation can implement automation tasks, such as automatic fault detection and isolation, load shedding, and voltage regulation to maintain system stability and reliability. These tasks are automatically performed via the transmission and reception of data across the PSA framework 100.

As shown in FIG. 1, a PSA server is communicatively coupled with switch 120 and switch 130. The PSA server collects, processes, and stores data from various Intelligent Electronic Devices (IEDs) and other components within the power system. The IED may be, for example, the IED 104. The PSA server enables the control and monitoring of power system operations, enabling operators to manage the system efficiently and respond to issues promptly. In some embodiments, the PSA server enables real-time data visualization and control capabilities at the OAS 106.

The IED 104 transmits data to the PSA server via the switch 120 and the switch 130. In some embodiments, the IED 104 performs protection, control, and monitoring functions. For example, the IED 104 detects faults and initiates protective actions, such as tripping circuit breakers to isolate faulty sections. The IED 104 also manages operations of power system components, such as voltage regulation and load balancing, and continuously monitors system parameters and provides data to the PSA server 102 for analysis.

The OAS 106 is an interface for human operators to interact with the power system. In some embodiments, the OAS 106 includes a human-machine interface (HMI) that provides real-time data visualization and control capabilities. The OAS 106 displays a real-time status of various components, such as transformers and circuit breakers, and enables operators to execute control commands, such as opening or closing circuit breakers. Moreover, the OAS 106 alerts operators to abnormal conditions, enabling quick response to issues and provides tools for analyzing historical data and trends to support decision-making.

The gateway 108 serves as a communication bridge between different parts of the power system. It facilitates data exchange between various devices and systems, ensuring seamless integration and interoperability. In examples, the gateway enables access to telecommunications 110. Telecommunications 110 enables the transmission and reception of data between the PSA framework 100 and remote sites, control centers, and field devices. In examples, telecommunications 110 enables operators to monitor and control power system components from a centralized location.

The central SCADA system 112 collects real-time data from various sensors and devices across the power system. Using the real time data, operators can control and manage the entire power system from a central location. In some embodiments, the central SCADA system provides tools for analyzing data and visualizing system status and can generates alarms for abnormal conditions.

The IDS 114 identifies unauthorized access attempts and potential cyber-attacks, and monitors network traffic to detect anomalies in real time. The IDS 114 may be, for example, a network-based IDS, host-based IDS, a signature based IDS, an anomaly based IDS, or any combinations thereof. A network-based IDS monitors traffic across the entire network, typically placed at strategic points like behind firewalls. A host-based IDS is installed on individual devices to monitor traffic to and from that specific device. A signature-based IDS compares network traffic against a database of known attack signatures. An anomaly-based IDS uses machine learning to establish a baseline of normal activity and detects deviations from this baseline. In examples, the IDS 114 integrates with other security tools (not shown) such as Security Information and Event Management (SIEM) systems, Static Application Security Testing (SAST) tools, Dynamic Application Security Testing (DAST) tools, Software Composition Analysis (SCA) tools, Database Security Scanning (DSS) tools, Mobile Application Security Testing (MAST) tools, Interactive Application Security Testing (IAST) tools, Application Security Testing as a Service (ASTaaS) tools, Correlation tools, Test Coverage Analyzer tools, Application Security Testing Orchestration (ASTO) tools, logging and monitoring tools, log management tools, or any combinations thereof. These other security tools can analyze computing resource assets and detect, identify, and assess vulnerabilities in those computing resource assets, as well as traffic received by or passing through the respective assets.

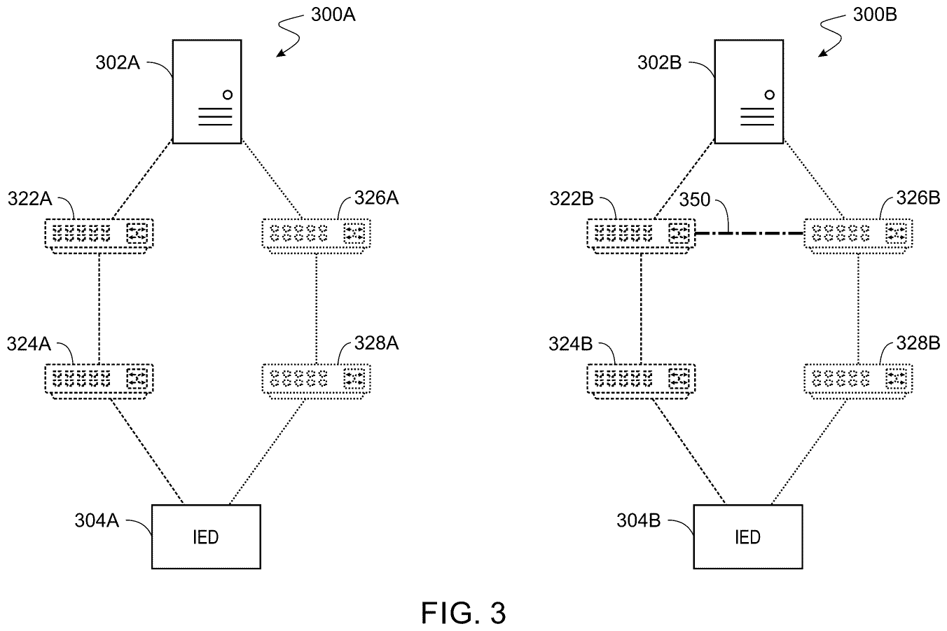

In some embodiments, the IDS 114 passively monitors network traffic associated with the central SCADA system 112, collecting data on communications between devices. The switch 120 and the switch 130 (collectively referred to as switches) may be the same as or similar to the switches 322A/B, 324A/B, 326A/B, 328A/B described with respect to FIG. 3. The switches 120 and 130 transmit and receive data packets between the PSA server 102, IED 104, and OAS 108. In some embodiments, the PSA framework 100 is configured with dual independent networks. For examples, the PSA framework is segmented into two or more parallel local area networks (LANs). For example, the switch 120 belongs to a LAN A, and the switch 130 belongs to a LAN B. PRP enables two parallel paths for the traffic from source to destination for the purposes of redundancy. In examples, the LANs are redundant such that duplicate data packets are sent over both switch 120 and switch 130 simultaneously. If one LAN is compromised, the other remains unaffected, thereby containing the impact of security breaches. By using two paths to transmit data, a compromise (security or otherwise) will not impact the availability of the system, and data will reach the intended destination.

In examples, the dual independent networks are LANs referred to as LAN A and LAN B. While physical LANs are described, the present systems and techniques can be used with virtual LANs and other Open Systems Interconnection (OSI) Level 2 configurations. The dual independent networks operate in parallel, ensuring that if one network fails, the other can continue to function without interruption. In some embodiments, switches of the PSA framework 100 include multiple ports and can be communicatively coupled to two separate, independent networks. In examples the switch 120 and the switch 130 are Ethernet switches of the PSA framework 100 and are configured for association with a respective LAN under PRP. In examples, the switches are configured in a Layer 2 connection between LANs, such that the switches communicate at the data link layer (Layer 2) of an OSI model. A switch inspects the data packets upon ingress to determine if the data packet belongs to the LAN associated with the switch. A data packet that does not belong to the LAN associated with the switch is referred to as a violating packet. In examples, violating packets are discarded at the switch without further processing.

In some embodiments, the IDS 114 monitors network traffic and detects suspicious activities or known threats, including violating packets. For example, violating packets as identified by switches of the network are transmitted to the IDS 114. The violating packets are analyzed as an indicator of compromise (IOC). These IOC can potentially alert of a cybersecurity incident. In some embodiments, the reception of violating packets causes the creation of a Denial of Service (DoS) condition. A DoS can occur when legitimate users are unable to access information systems, devices, or other network resources due to the actions of a malicious actor. This is typically achieved by overwhelming the target with a flood of traffic or requests, causing it to become unresponsive or crash. For example, a DoS attack can include an attack vector where the attacker tries to overwhelm the system. In a PRP networks, a DoS attack can be achieved by communicatively coupling LAN A to LAN B, as this will cause the network switch CAM tables to continuously change. This CAM table instability would ultimately cause the network to fail. A higher quantity and/or frequency of violating packets would accelerate the DoS.

In the PSA framework 100, PRP causes the network to be physically segregated into two ethernet segments. An OSI Layer 2 connection between these segments will cause a failure of the network. The present systems and techniques enable detection and the prevention of transmission of data packets from a first PRP LAN on the opposite LAN. In examples, the switches of the PRP network system are switches that operate at a data link layer of an OSI model that facilitates network communications between different systems and devices.

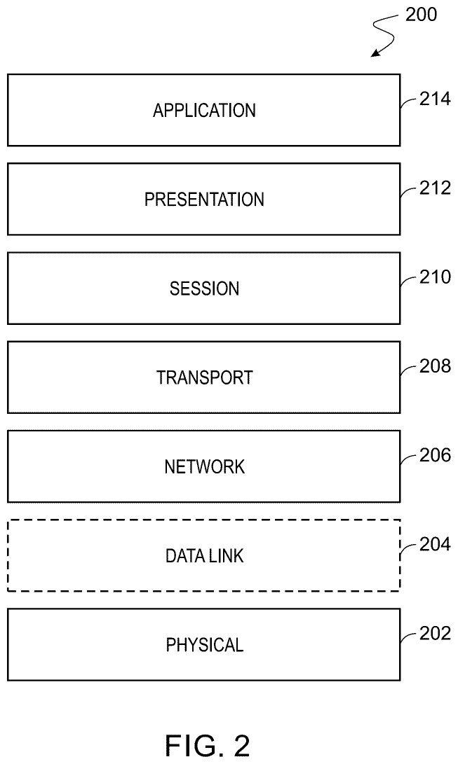

FIG. 2 shows an OSI model for network communications. As shown in the example of FIG. 2, the OSI model divides network communications into seven distinct layers, each with specific functions.

A physical layer 202 represents a lowest layer of the OSI model. The physical layer 202 enables the physical connection between devices. In particular, the physical layer enables the transmission and reception of raw bitstreams over a physical medium such as cables, switches, and the like.

A data link layer 204 enables node-to-node data transfer and handles error detection and correction from the physical layer. The data link layer 204 includes protocols like Ethernet and MAC addresses.

A network layer 206 is responsible for data routing, forwarding, and addressing. The network layer 206 determines the best path to send data from the source to the destination. Protocols like IP (Internet Protocol) operate at this layer.

A transport layer 208 ensures reliable data transfer between end systems. The transport layer 208 manages error detection and recovery, as well as flow control. Protocols like TCP (Transmission Control Protocol) and UDP (User Datagram Protocol) are part of the transport layer 208.

A session layer 210 manages sessions or connections between applications. The session layer 210 establishes, maintains, and terminates connections, ensuring data exchange is properly synchronized.

A presentation layer 212 translates data between the application layer and the network. The presentation layer 212 handles data encryption, compression, and translation, ensuring that data is in a usable format.

An application layer 214 is the topmost layer of the OSI model 200, which provides network services directly to end-user applications. The application layer 214 includes protocols like HTTP, FTP, and SMTP, which support web browsing, file transfer, and email services.

Each layer serves a specific function and communicates with the layers directly above and below it, ensuring a structured and systematic approach to network communication.

In examples, the switches of a network operate at the data link layer 204 (e.g., Layer 2) of the OSI model. MAC (Media Access Control) addresses are used to identify devices on the network. Switches and bridges are used to forward packets based on MAC addresses. These devices enable traffic management within a LAN and can connect multiple LAN segments.

FIG. 3 shows a PRP network architecture 300. The PRP network architecture 300 may be applied to the PRP network system 100 of FIG. 1.

In the example of FIG. 3, a two PRP networks 300A and 300B as shown. Each respective network includes an IED 304A/B (collectively referred to as IEDs 304). For ease of description, IEDs are described. However, the IEDs may also be Dual Attached Nodes (DANs). A DAN is a device connected to two separate networks simultaneously. Each DAN has two network interfaces, allowing it to send and receive data over both networks independently. Each respective network includes a number of switches 322A/B, 324A/B, 326A/B, 328A/B. Additionally, each respective network is communicatively coupled with a client device 302A/B (collectively referred to as client devices 302). The client devices 302 are the same as or similar to the PSA server 102 of FIG. 1.

In the PRP network 300A, a first LAN A including switch 322A and switch 324A is physically separate and independent from a second LAN B including switch 326A and switch 328A. Similarly, in the PRP network 300B, a first LAN A including switch 322B and switch 324B is physically separate and independent from a second LAN B including switch 326B and switch 328B. In the PRP network 300B, an interconnection 350 between LAN A and LAN B can cause disruptions to the networks and can result in failure of the network (e.g., an inability to send data across the network). Inadvertent (or deliberate) interconnections of the LAN's would result in a failure of the network. Further, this interconnection will lead to CAM table instability of the ethernet switch, as the same source MAC address will be received from two different ports. For ease of illustration, each LAN is shown with two Ethernet switches. However, each LAN can include any number of switches.

To prevent CAM table instability, the Redundancy Control Trailer (RCT) of a PRP data packet is inspected by each switch. This trailer is appended to each PRP data packet to manage redundancy and ensure seamless failover. Each switch is configured to store data that assigns the respective switch to a LAN. In this manner, Ethernet switches in a PRP network system are assigned to a LAN. Each switch inspects the incoming trailer of data packets and discards violating packets.

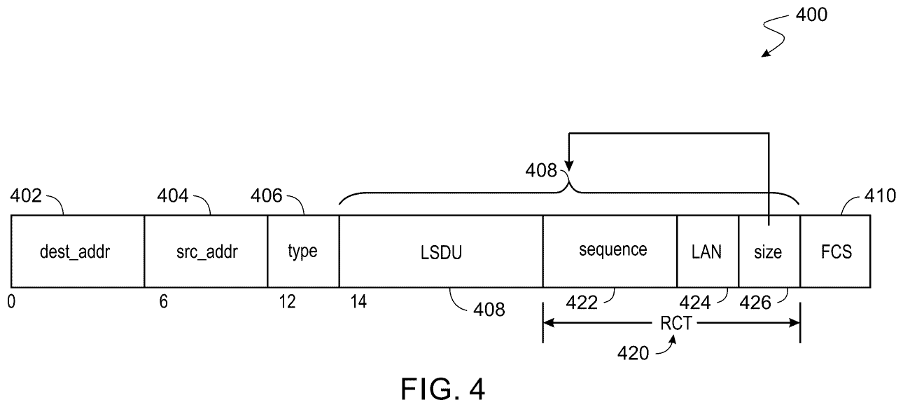

FIG. 4 shows a PRP packet structure. As shown in FIG. 4, a PRP packet of data 400 includes information to ensure redundancy and seamless failover. In some embodiments, the PRP packet is the same as or similar to an Ethernet packet of data. For example, the PRP packet includes a Destination MAC Address 402, a Source MAC Address 404, an EtherType/Length 406, a Link Service Data Unit (LSDU) 408, and a Frame Check Sequence (FCS) 410. PRP adds a Redundancy Control Trailer (RCT) 420 to the Ethernet packet. The RCT includes a Sequence Number 422, a LAN identifier 424, and a frame size 426. In examples, the sequence number 422 is a unique number for each packet to help identify and discard duplicates. The LAN identifier 424 indicates which of the two independent networks (LAN A or LAN B) is used to transmit a respective packet. The frame size 426 indicates the size of the packet, including the RCT.

Referring again to FIG. 3, in operation, a sending node, such as an IED 304, duplicates the packet and sends it over both LAN A and LAN B. Traditionally, a receiving node receives packets from both LAN A and LAN B, processes the first packet that arrives, and discards the duplicate based on the sequence number. However, the transmission of a packet on LAN A that belongs to LAN B (or vice versa), as identified by the LAN identifier 424 of FIG. 4 can result in failure of both LAN A and LAN B. This can occur, for example, due to an interconnection 350 between LAN A and LAN B. In the example of FIG. 3, network 300B is subject to failure due to the interconnection 350.

Referring again to FIG. 4, the RCT 420 is used to identify the sequence number 422, 16-bit LAN identifier 424, and 12-bit frame size 426. In examples, an identifier for LAN A is 1010 (0xA), and an identifier for LAN B is 1011 (0xB). To assign a switch to a LAN, the ethernet switch is manually configured. In examples, an ethernet switch is manually configured via a terminal emulator. For example, a secure shell and Telnet client are used to establish secure, encrypted communications with respective switches. In some embodiments, scripts are used to customize configuration settings for each respective switch, which include a LAN assignment. In this manner, the switch can identify the LAN that is belongs to, inspect the LAN identifier of incoming PRP packets of data, and discard those packet of data that do not match the LAN of the ethernet switch.

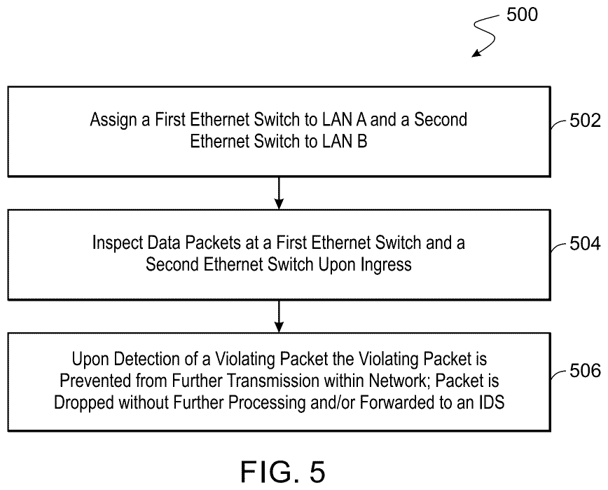

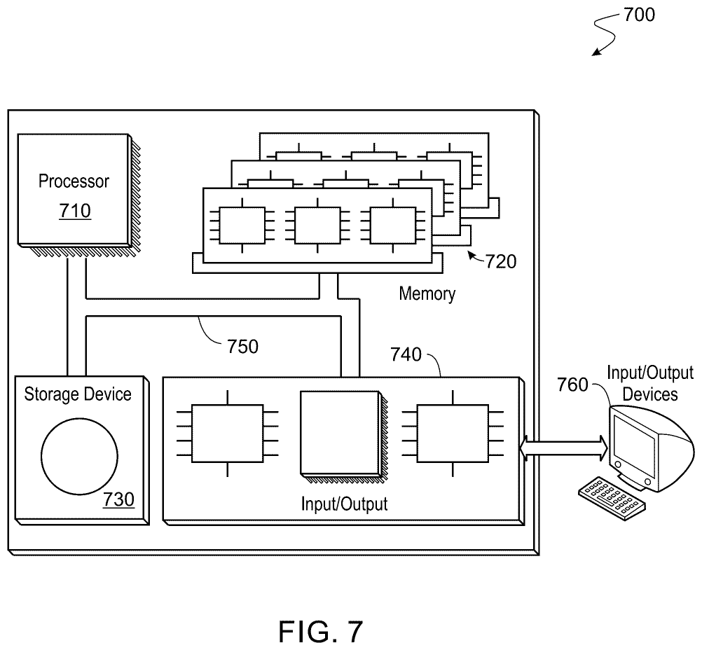

FIG. 5 is a process flow diagram of a process 500 that enables detection and prevention of packet ingress between PRP LANs. In some embodiments, the process 500 is executed by the controller 700 of FIG. 7.

At block 502, a first Ethernet switch is assigned to LAN A, and a second Ethernet switch is assigned to LAN B. In examples, the switch assignment to a LAN is done manually upon initial configuration of the system. If the LANs configured under PRP are interconnected, the interconnection will cause network disruptions and failures. For example, this interconnection will lead to CAM table instability of an Ethernet switch, as the same source Medium Access Control (MAC) address will be received from two different ports.

At block 504, the first Ethernet switch and the second Ethernet switch inspect data packets upon ingress. In particular, each respective Ethernet switch inspects a RCT field of the data packets. Data packets at the first Ethernet switch or the second Ethernet switch that are not assigned to a same LAN as the particular switch on which transmission occurs are detected and classified as violating packets. For example, the LAN identified in an RCT field of a data packet transmitted to a switch is compared to the LAN assigned to the switch. If the LAN identified in the RCT field does not match the LAN assigned to the switch, the data packet is detected and classified as a violating packet. A violating packet is a packet detected at a first LAN that is assigned to the second LAN as designated in the respective RCT field. For example, a packet that is assigned to LAN B and is observed by (e.g., ingresses or is transmitted to) a switch that is assigned to LAN A (or vice-versa) is a violating packet.

At block 506, upon detection of a violating packet, the violating packet is prevented from further transmission within network. In examples, the port of the Ethernet switch that detects the violating packet is shut down. In examples, the violating packet is discarded by the Ethernet switch that detected the violating packet. In examples, the violating packet is forwarded to an IDS and evaluated as an indicator of compromise. In some embodiments, the shut down port remains shut down until manually restarted. In some embodiments, the shut down port remains shut down until predetermined criteria are met. In examples, the predetermined criteria is configured through network automation via a Network Management Systems (NMS). For example, predetermined criteria may include shutting down the port for a specified period of time via network automation.

In examples, an alarm is generated in response to detecting packets that are not assigned to a same LAN of a respective Ethernet switch. For example, an alarm is triggered when a violating packet is detected. In examples, an LED on the front of the Ethernet switch can emit a visual indication of the alarm. Additionally, in examples, an Ethernet switch includes a contact that is wired to another device that emits a visual alarm, an auditory alarm, a haptic alarm, or any combinations thereof. In examples, the alarm is generated by software associated with the switch. For example, the software generates a visual alarm, an auditory alarm, a haptic alarm, or any combinations thereof using output devices such as a display or speaker.

In some embodiments, the Ethernet switches support a Simple Network Management Protocol (SNMP) that enables devices on a network to share information about their status and configuration. In examples, the SNMP is used to monitor network-attached devices for conditions, such as a violating packet, that warrant attention to ensure continued operation of the network. Network devices such as routers, switches, and servers are network nodes that contain an SNMP agent and reside on a managed network. The SNMP agents collect and store management information and make it available to Network Management Systems (NMS). SNMP enables operations such as retrieving data from a device (GET), changing settings on a device (SET), and receiving alerts from devices (TRAP). In power systems automation, SNMP manages and monitors network devices such as routers, switches, and servers, ensuring the reliable operation of the communication infrastructure. In some embodiments, the Network Management System (NMS) is used to emit the alarm audibly, visually, or any combinations thereof.

FIG. 6 illustrates hydrocarbon production operations 600 that include both one or more field operations 610 and one or more computational operations 612, which exchange information and control exploration for the production of hydrocarbons. In some implementations, outputs of techniques of the present disclosure can be performed before, during, or in combination with the hydrocarbon production operations 600, specifically, for example, either as field operations 610 or computational operations 612, or both.

Examples of field operations 610 include forming/drilling a wellbore, hydraulic fracturing, producing through the wellbore, injecting fluids (such as water) through the wellbore, to name a few. In some implementations, methods of the present disclosure can trigger or control the field operations 610. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 610 and responsively triggering the field operations 610 including, for example, generating plans and signals that provide feedback to and control physical components of the field operations 610. Alternatively or in addition, the field operations 610 can trigger the methods of the present disclosure. For example, implementing physical components (including, for example, hardware, such as sensors) deployed in the field operations 610 can generate plans and signals that can be provided as input or feedback (or both) to the methods of the present disclosure.

Examples of computational operations 612 include one or more computer systems 620 that include one or more processors and computer-readable media (e.g., non-transitory computer-readable media) operatively coupled to the one or more processors to execute computer operations to perform the methods of the present disclosure. The computational operations 612 can be implemented using one or more databases 618, which store data received from the field operations 610 and/or generated internally within the computational operations 612 (e.g., by implementing the methods of the present disclosure) or both. For example, the one or more computer systems 620 process inputs from the field operations 610 to assess conditions in the physical world, the outputs of which are stored in the databases 618. For example, seismic sensors of the field operations 610 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 612 where they are stored in the databases 618 and analyzed by the one or more computer systems 620.

In some implementations, one or more outputs 622 generated by the one or more computer systems 620 can be provided as feedback/input to the field operations 610 (either as direct input or stored in the databases 618). The field operations 610 can use the feedback/input to control physical components used to perform the field operations 610 in the real world.

For example, the computational operations 612 can process the seismic data to generate three-dimensional (3D) maps of the subsurface formation. The computational operations 612 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 612 to process new information about the formation and control the drilling to adjust to the observed conditions in real-time.

The one or more computer systems 620 can update the 3D maps of the subsurface formation as information from one exploration well is received and the computational operations 612 can adjust the location of the next exploration well based on the updated 3D maps. Similarly, the data received from production operations can be used by the computational operations 612 to control components of the production operations. For example, production well and pipeline data can be analyzed to predict slugging in pipelines leading to a refinery and the computational operations 612 can control machine operated valves upstream of the refinery to reduce the likelihood of plant disruptions that run the risk of taking the plant offline.

In some implementations of the computational operations 612, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 7 is a schematic illustration of an example controller 700 (or control system) for that enables detecting and preventing packet ingress between PRP LANs. For example, the controller 700 may be operable according to the process 500 of FIG. 5. In some embodiments, the controller 700 is the same as or similar to the computer systems 620 of FIG. 6. The controller 700 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 700 includes a processor 710, a memory 720, a storage device 730, and an input/output interface 740 communicatively coupled with input/output devices 760 (for example, displays, keyboards, measurement devices, sensors, valves, pumps). Each of the components 710, 720, 730, and 740 are interconnected using a system bus 750. The processor 710 is capable of processing instructions for execution within the controller 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output interface 740.

The memory 720 stores information within the controller 700. In one implementation, the memory 720 is a computer-readable medium. In one implementation, the memory 720 is a volatile memory unit. In another implementation, the memory 720 is a nonvolatile memory unit.

The storage device 730 is capable of providing mass storage for the controller 700. In one implementation, the storage device 730 is a computer-readable medium. In various different implementations, the storage device 730 may be a floppy disk device, a hard disk device, an optical disk device, or a tape device.

The input/output interface 740 provides input/output operations for the controller 700. In one implementation, the input/output devices 760 includes a keyboard and/or pointing device. In another implementation, the input/output devices 760 includes a display unit for displaying graphical user interfaces.

There can be any number of controllers 700 associated with, or external to, a computer system containing controller 700, with each controller 700 communicating over a network. Further, the terms “client,” “user,” and other appropriate terminology can be used interchangeably, as appropriate, without departing from the scope of the present disclosure. Moreover, the present disclosure contemplates that many users can use one controller 700 and one user can use multiple controllers 700.

### Embodiments

According to some non-limiting embodiments or examples, provided is a system, including: a first Ethernet switch assigned to LAN A and a second Ethernet switch assigned to LAN B of a network configured under a Parallel Redundancy Protocol (PRP), where the first Ethernet switch and the second Ethernet switch inspect Redundancy Control Trailers (RCTs) of data packets transmitted to respective switches, and in response to detecting that a LAN identified by a respective RCT of a data packet does not match a LAN assigned to the respective switches, classifying the data packet as a violating packet by the first Ethernet switch or the second Ethernet switch.

According to some non-limiting embodiments or examples, provided is a computer-implemented method that enables detecting and preventing packet ingress between Parallel Redundancy Protocol (PRP) Local Area Networks (LAN), including: inspecting Redundancy Control Trailers (RCTs) of data packets at a first Ethernet switch assigned to LAN A and a second Ethernet switch assigned to LAN B of a network configured under a Parallel Redundancy Protocol (PRP); and classifying the data packets as violating packets by the first Ethernet switch or the second Ethernet switch when the first Ethernet switch or the second Ethernet switch detects that a LAN identified by a respective RCT of a data packet does not match its assigned LAN.

According to some non-limiting embodiments or examples, provided is an apparatus including a non-transitory, computer readable, storage medium that stores instructions that, when executed by at least one processor, cause the at least one processor to perform operations including: inspecting Redundancy Control Trailers (RCTs) of data packets at a first Ethernet switch assigned to LAN A and a second Ethernet switch assigned to LAN B of a network configured under a Parallel Redundancy Protocol (PRP); and classifying the data packets as violating packets by the first Ethernet switch or the second Ethernet switch when the first Ethernet switch or the second Ethernet switch detects that a LAN identified by a respective RCT of a data packet does not match its assigned LAN.

Further non-limiting aspects or embodiments are set forth in the following numbered embodiments:

Embodiment 1: A system, including: a first Ethernet switch assigned to LAN A and a second Ethernet switch assigned to LAN B of a network configured under a Parallel Redundancy Protocol (PRP), where the first Ethernet switch and the second Ethernet switch inspect Redundancy Control Trailers (RCTs) of data packets transmitted to respective switches, and in response to detecting that a LAN identified by a respective RCT of a data packet does not match a LAN assigned to the respective switches, classifying the data packet as a violating packet by the first Ethernet switch or the second Ethernet switch.

Embodiment 2: The system of any preceding embodiment, where the violating packet is prevented from further transmission within the network.

Embodiment 3: The system of any preceding embodiment, where a port of the first Ethernet switch or the second Ethernet switch where the violating packet is transmitted is shut down.

Embodiment 4: The system of any preceding embodiment, where the violating packet is discarded by the first Ethernet switch or the second Ethernet switch that detected the violating packet.

Embodiment 5: The system of any preceding embodiment, where the violating packet is forwarded to an Intrusion Detection System (IDS) and evaluated as an indicator of compromise.

Embodiment 6: The system of any preceding embodiment, where an alarm is generated via a network management system upon detection of the violating packet.

Embodiment 7: The system of any preceding embodiment, where the first Ethernet switch and the second Ethernet switch are assigned to a respective LAN manually upon initial configuration of the network under PRP.

Embodiment 8: A computer-implemented method that enables detecting and preventing packet ingress between Parallel Redundancy Protocol (PRP) Local Area Networks (LAN), including: inspecting Redundancy Control Trailers (RCTs) of data packets at a first Ethernet switch assigned to LAN A and a second Ethernet switch assigned to LAN B of a network configured under a Parallel Redundancy Protocol (PRP); and classifying the data packets as violating packets by the first Ethernet switch or the second Ethernet switch when the first Ethernet switch or the second Ethernet switch detects that a LAN identified by a respective RCT of a data packet does not match its assigned LAN.

Embodiment 9: The method of any preceding embodiment, where the violating packets are prevented from further transmission within the network.

Embodiment 10: The method of any preceding embodiment, where a port of the first Ethernet switch or the second Ethernet switch that transmits the violating packets is shut down.

Embodiment 11: The method of any preceding embodiment, where the violating packets are discarded by the first Ethernet switch or the second Ethernet switch.

Embodiment 12: The method of any preceding embodiment, where the violating packets are forwarded by the first Ethernet switch or the second Ethernet switch to an Intrusion Detection System (IDS) and evaluated as an indicator of compromise.

Embodiment 13: The method of any preceding embodiment, where an alarm is generated via a network management system in response to violating packets at the first Ethernet switch or the second Ethernet switch.

Embodiment 14: The method of any preceding embodiment, where the first Ethernet switch and the second Ethernet switch are assigned to a respective LAN manually upon initial configuration of the network under PRP.

Embodiment 15: An apparatus including a non-transitory, computer readable, storage medium that stores instructions that, when executed by at least one processor, cause the at least one processor to perform operations including: inspecting Redundancy Control Trailers (RCTs) of data packets at a first Ethernet switch assigned to LAN A and a second Ethernet switch assigned to LAN B of a network configured under a Parallel Redundancy Protocol (PRP); and classifying the data packets as violating packets by the first Ethernet switch or the second Ethernet switch when the first Ethernet switch or the second Ethernet switch detects that a LAN identified by a respective RCT of a data packet does not match its assigned LAN.

Embodiment 16: The apparatus of any preceding embodiment, where the violating packets are prevented from further transmission within the network.
Embodiment 17: The apparatus of any preceding embodiment, where a port of the first Ethernet switch or the second Ethernet switch that transmits the violating packets is shut down.

Embodiment 18: The apparatus of any preceding embodiment, where the violating packets are discarded by the first Ethernet switch or the second Ethernet switch.

Embodiment 19: The apparatus of any preceding embodiment, where the violating packets are forwarded by the first Ethernet switch or the second Ethernet switch to an Intrusion Detection System (IDS) and evaluated as an indicator of compromise.

Embodiment 20: The apparatus of any preceding embodiment, where an alarm is generated via a network management system in response to violating packets at the first Ethernet switch or the second Ethernet switch.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

What is claimed is:

1. A system, comprising:
a first Ethernet switch assigned to LAN A and a second Ethernet switch assigned to LAN B of a network configured under a Parallel Redundancy Protocol (PRP), wherein the first Ethernet switch and the second Ethernet switch inspect Redundancy Control Trailers (RCTs) of data packets transmitted to respective switches, and in response to detecting that a LAN identified by a respective RCT of a data packet does not match a LAN assigned to the respective switches, classifying the data packet as a violating packet by the first Ethernet switch or the second Ethernet switch.

2. The system of claim 1, wherein the violating packet is prevented from further transmission within the network.

3. The system of claim 1, wherein a port of the first Ethernet switch or the second Ethernet switch where the violating packet is transmitted is shut down.

4. The system of claim 1, wherein the violating packet is discarded by the first Ethernet switch or the second Ethernet switch that detected the violating packet.

5. The system of claim 1, wherein the violating packet is forwarded to an Intrusion Detection System (IDS) and evaluated as an indicator of compromise.

6. The system of claim 1, wherein an alarm is generated via a network management system upon detection of the violating packet.

7. The system of claim 1, wherein the first Ethernet switch and the second Ethernet switch are assigned to a respective LAN manually upon initial configuration of the network under PRP.

8. A computer-implemented method that enables detecting and preventing packet ingress between Parallel Redundancy Protocol (PRP) Local Area Networks (LAN), comprising:
inspecting Redundancy Control Trailers (RCTs) of data packets at a first Ethernet switch assigned to LAN A and a second Ethernet switch assigned to LAN B of a network configured under a Parallel Redundancy Protocol (PRP); and
classifying the data packets as violating packets by the first Ethernet switch or the second Ethernet switch when the first Ethernet switch or the second Ethernet switch detects that a LAN identified by a respective RCT of a data packet does not match its assigned LAN.

9. The method of claim 8, wherein the violating packets are prevented from further transmission within the network.

10. The method of claim 8, wherein a port of the first Ethernet switch or the second Ethernet switch that transmits the violating packets is shut down.

11. The method of claim 8, wherein the violating packets are discarded by the first Ethernet switch or the second Ethernet switch.

12. The method of claim 8, wherein the violating packets are forwarded by the first Ethernet switch or the second Ethernet switch to an Intrusion Detection System (IDS) and evaluated as an indicator of compromise.

13. The method of claim 8, wherein an alarm is generated via a network management system in response to violating packets at the first Ethernet switch or the second Ethernet switch.

14. The method of claim 8, wherein the first Ethernet switch and the second Ethernet switch are assigned to a respective LAN manually upon initial configuration of the network under PRP.

15. An apparatus comprising a non-transitory, computer readable, storage medium that stores instructions that, when executed by at least one processor, cause the at least one processor to perform operations comprising:
inspecting Redundancy Control Trailers (RCTs) of data packets at a first Ethernet switch assigned to LAN A and a second Ethernet switch assigned to LAN B of a network configured under a Parallel Redundancy Protocol (PRP); and
classifying the data packets as violating packets by the first Ethernet switch or the second Ethernet switch when the first Ethernet switch or the second Ethernet switch detects that a LAN identified by a respective RCT of a data packet does not match its assigned LAN.

16. The apparatus of claim 15, wherein the violating packets are prevented from further transmission within the network.

17. The apparatus of claim 15, wherein a port of the first Ethernet switch or the second Ethernet switch that transmits the violating packets is shut down.

18. The apparatus of claim 15, wherein the violating packets are discarded by the first Ethernet switch or the second Ethernet switch.

19. The apparatus of claim 15, wherein the violating packets are forwarded by the first Ethernet switch or the second Ethernet switch to an Intrusion Detection System (IDS) and evaluated as an indicator of compromise.

20. The apparatus of claim 15, wherein an alarm is generated via a network management system in response to violating packets at the first Ethernet switch or the second Ethernet switch.
